(19) United States
(12) Patent Application Publication
(10) Pub. No.: US 2016/0037101 A1
(43) Pub. Date: Feb. 4, 2016

(54) Apparatus and Method for Capturing Images

(71) Applicant: Samsung Electronics Co., Ltd., Suwon-si (KR)

(72) Inventors: Eun-Sub Shim, Anyang-si (KR); Young-Chan Kim, Seongnam-si (KR); Moo-Sup Lim, Yongin-si (KR)

(21) Appl. No.: 14/711,289

(22) Filed: May 13, 2015

(30) Foreign Application Priority Data
Jul. 31, 2014 (KR) 10-2014-0098325

(51) Int. Cl. H04N 5/365; H04N 5/378; H04N 5/235; H04N 5/374

(52) U.S. Cl. CPC H04N 5/3653; H04N 5/374; H04N 5/378; H04N 5/2353

(57) ABSTRACT

An apparatus and a method for capturing images are disclosed. The apparatus for capturing images includes an active pixel sensor (APS) array including a plurality of active pixels each including a photo diode and a storage diode, the plurality of active pixels being arranged in an array of N rows and M columns (where N and M are natural numbers of 2 or more), and an image signal processor that corrects an image signal output by the APS array. The APS array includes N pixel sensor rows, and the image signal processor removes noise from the image signal by using image signals that are sequentially output from non-adjacent ones of the pixel sensor rows.

### CROSS-REFERENCE TO RELATED APPLICATION

This application claims priority from Korean Patent Application No. 10-2014-0098325 tiled on Jul. 31, 2014 in the Korean Intellectual Property Office, and all the benefits accruing therefrom under 35 U.S.C. 119, the disclosure of which is incorporated by reference herein in its entirety.

### TECHNICAL FIELD

The present inventive concept relates to an apparatus and a method for capturing images.

### BACKGROUND

A digital image capturing apparatus includes an image sensor. An image sensor is a semiconductor device that converts optical information into an electric signal that can be recorded and manipulated. An image sensor may include a charge coupled device (CCD) image sensor and/or a complementary metal-oxide semiconductor (CMOS) image sensor. An exposure system of a CMOS image sensor may include a rolling shutter system and/or a global shutter system.

### SUMMARY

Some embodiments of the present inventive concept provide an apparatus for capturing images that can correct an undesired output generated at a readout time when images are captured by using a global shutter.

Some embodiments of the present inventive concept may also provide a method for capturing images that can correct an undesired output generated at a readout time when images are captured by using a global shutter.

An embodiment of the present inventive concept provides an apparatus for capturing images including an active pixel sensor (APS) array including a plurality of active pixels including a photo diode and a storage diode, respectively, the plurality of active pixels being arranged in an N×M (where N and M are natural numbers of 2 or more) array; and an image signal processor that corrects an image signal output by the APS array. The APS array includes N pixel sensor rows, and the image signal processor removes noise of the image signal by using an image signal that is sequentially output from non-adjacent ones of the pixel sensor rows.

The apparatus may further include a row driver that sequentially transfers a readout signal to non-adjacent ones of the pixel sensor rows, wherein the row driver sequentially transfers the readout signal to all odd-numbered rows among the N pixel sensor rows and sequentially transfers the readout signal to all even-numbered rows among the N pixel sensor rows.

The image signal processor may apply a linear model to the odd-numbered row and the even-numbered row which are adjacent to each other in the APS array to correct the image signals output from the odd-numbered row and the even-numbered row.

The readout signal may be sequentially transferred to the odd-numbered rows and thereafter, the readout signal may be sequentially transferred to the even-numbered rows.

The readout signal may be sequentially transferred to the even-numbered rows and thereafter, the readout signal may be sequentially transferred to the odd-numbered rows.

The image signal processor may receive the image signals for all odd-numbered rows among the N pixel sensor rows according to a predetermined order and thereafter, receive the image signals for even-numbered rows positioned below the odd-numbered rows in the order of receiving the image signals for the odd-numbered rows.

The image signal processor may apply the linear model to the odd-numbered row and the even-numbered row which are adjacent to each other in the APS array to correct the image signals output from the odd-numbered row and the even-numbered row.

The image signal processor may sequentially receive image signals for (3n−2)-th (where n is a natural number) rows among the N pixel sensor rows, sequentially receive image signals for (3p−1)-th (where p is an odd number) rows among the N pixel sensor rows, sequentially receive image signals for 3q (where q is a natural number) rows among the N pixel sensor rows, and sequentially receive image signals for (3r−1)-th (where r is an even number) rows among the N pixel sensor rows.

The image signal processor applies a log function model or an exponential function model to three adjacent pixel sensor rows among the N pixel sensor rows to corrects the output image signals.

The APS array may include a plurality of active pixels in which an operation of the global shutter is available.

Another embodiment of the present inventive concept provides an apparatus for capturing images, including an APS array including a plurality of active pixels, and transfer lines and selection lines connected to the plurality of active pixels, respectively, the active pixel including a photo diode and a storage diode; a row driver transferring a first driving signal and a second driving signal to the transfer line and the selection line, respectively; and an image signal processor correcting an image signal output by the APS array. The plurality of transfer lines and the plurality of selection lines are arranged for each row of the APS array to be connected with the active pixels positioned on the same row. The first driving signal is simultaneously transferred to all of the plurality of active pixels, the second driving signal is non-sequentially transferred to the respective rows of the APS array. The image signal processor removes noise of the image signal by using image signals sequentially output from non-adjacent ones of the rows of the APS array.

The active pixel may include a drive transistor that is controlled by the first driving signal of the transfer line to provide an output of the photo diode to the storage diode, and a select transistor that is controlled by the second driving signal of the selection line to provide an output of the storage diode to the image signal processor.

The row driver may sequentially transfer the second driving signal to odd numbered ones of the plurality of selection lines, and sequentially transfer the second driving signal to even numbered ones of the plurality of selection lines.

The image signal processor may apply the linear model to the odd-numbered row and the even-numbered row which are adjacent to each other in the APS array to correct image signals output from the odd-numbered row and the even-numbered row.

The row driver may transfer the second driving signal to odd numbered selection lines among the plurality of selection lines according to a predetermined order and thereafter, transfer the second driving signal to even numbered selection lines positioned below the odd numbered selection lines in the order of transferring the second driving signal to the odd numbered selection lines.

The image signal processor applies the linear model to adjacent rows in the APS array to correct image signals output from the adjacent rows.

The row driver may sequentially transfer the second driving signal to (3n−2)-th (where a is a natural number) selection lines among the plurality of selection lines, sequentially transfer the second driving signal to (3p−1)-th (where p is an odd number) selection lines among the plurality of selection lines, sequentially transfer the second driving signal to 3q-th (where q is the natural number) selection lines among the plurality of selection lines, and sequentially transfer the second driving signal to (3r−1)-th (where r is an even number) selection lines among the plurality of selection lines.

The image signal processor may apply a log function model or an exponential function model to three adjacent rows among rows of the APS array to correct images signals output from the three adjacent rows.

The active pixel may include a CMOS image pixel.

Yet another embodiment of the present inventive concept provides a method for capturing images. The method includes providing an APS array in which a plurality of active pixels each including a photo diode and a storage diode, and a plurality of transfer lines and a plurality of selection lines are arranged, the transfer line and the selection line being arranged on each row of the APS array; simultaneously transferring a first driving signal to the plurality of transfer lines; sequentially transferring a second driving signal to non-adjacent ones of the plurality of selection lines; and removing noise of the image signal by using image signals output from a plurality of adjacent rows in the APS array.

The transferring of the second driving signal may include sequentially transferring the second driving signal to odd numbered selection lines among the plurality of selection lines, and sequentially transferring the second driving signal to even numbered selection lines among the plurality of selection lines.

The transferring of the second driving signal may include transferring the second driving signal to odd numbered selection lines among the plurality of selection lines according to a predetermined order and thereafter, transferring the second driving signal to even numbered selection lines positioned below the odd numbered selection lines in the order of transferring the second driving signal to the odd numbered selection lines.

The transferring of the second driving signal may include sequentially transferring the second driving signal to (3n−2)-th (where n is a natural number) selection lines among the plurality of selection lines, sequentially transferring the second driving signal to 3p−1-th (where p is an even number) selection lines among the plurality of selection lines, sequentially transferring the second driving signal to 3q-th (where q is the natural number) selection lines among the plurality of selection lines, and sequentially transferring the second driving signal to (3r−1)-th (where r is an odd number) selection lines among the plurality of selection lines.

Other detailed contents of the embodiments are included in the description and drawings.

The technical objects of the present inventive concept are not limited to the aforementioned technical objects, and other technical objects, which are not mentioned above, will be apparent to those skilled in the art from the following description.

### BRIEF DESCRIPTION OF THE DRAWINGS

The above and other features and advantages of the present inventive concept will become more apparent by describing in detail embodiments thereof with reference to the attached drawings in which:

FIG. 1 is a block diagram of an apparatus for capturing images according to an embodiment of the present inventive concept;

FIG. 2 is a block diagram of an apparatus for capturing images according to another embodiment of the present inventive concept;

FIG. 3 is a diagram for describing an APS array of FIG. 2;

FIG. 4 is a circuit diagram for describing the structure of active pixels included in the APS array of FIG. 3;

FIG. 5 is a timing diagram for describing a signal input in an image sensor according to an embodiment of the present inventive concept;

FIG. 6 is a diagram for describing an operation of an image signal processor according to an embodiment of the present inventive concept;

FIG. 7 is a timing diagram for describing a signal input in an image sensor according to another embodiment of the present inventive concept;

FIG. 8 is a diagram for describing an operation of an image signal processor according to another embodiment of the present inventive concept;

FIG. 9 is a timing diagram for describing a signal input in an image sensor according to yet another embodiment of the present inventive concept;

FIG. 10 is a diagram for describing an operation of an image signal processor according to yet another embodiment of the present inventive concept;

FIG. 11 is a timing diagram for describing a signal input in an image sensor according to still another embodiment of the present inventive concept;

FIG. 12 is a diagram for describing an operation of an image signal processor according to still another embodiment of the present inventive concept;

FIG. 13 is a block diagram illustrating an example in which the apparatus for capturing images according to the embodiments of the present inventive concept is applied to a computing system; and

FIG. 14 is a block diagram illustrating one example of an interface used in the computing system of FIG. 13.

### DETAILED DESCRIPTION OF THE EMBODIMENTS

Advantages and features of the present inventive concept and methods of accomplishing the same may be understood more readily by reference to the following detailed description of preferred embodiments and the accompanying drawings. The present inventive concept may, however, be embodied in many different forms and should not be construed as being limited to the embodiments set forth herein. Rather, these embodiments are provided so that this disclosure will be thorough and complete and will fully convey the concept of the invention to those skilled in the art, and the present inventive concept will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of this specification and the relevant art and this specification and will not be interpreted in an idealized or overly formal sense unless expressly so defined herein.

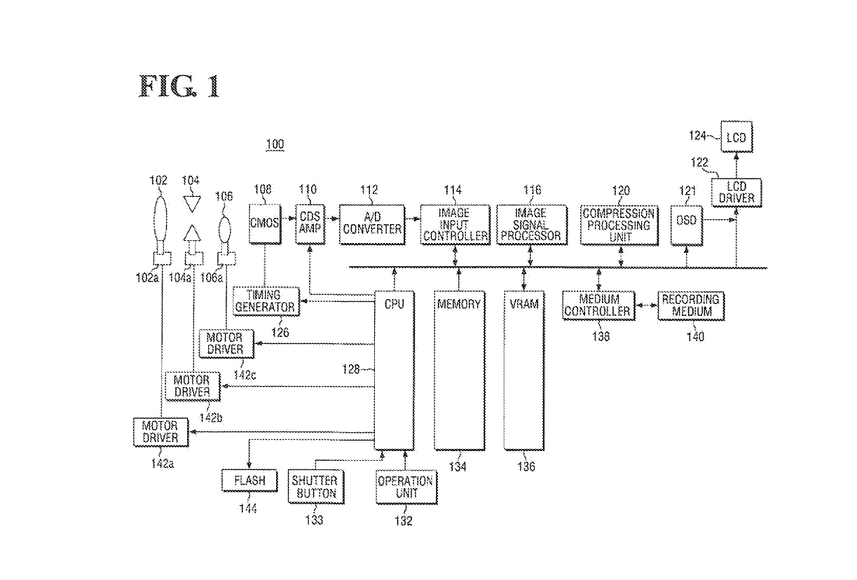

Hereinafter, an apparatus for capturing images according to an embodiment of the present inventive concept will be described with reference to FIGS. 1 to 4.

FIG. 1 is a block diagram of an apparatus for capturing images according to an embodiment of the present inventive concept. Hereinafter, a configuration of the apparatus for capturing images according to the embodiment of the present inventive concept will be described with reference to FIG. 1.

Referring to FIG. 1, an image capturing apparatus 100 according to some embodiments of the present inventive concepts may include a zoom lens 102, an iris 104, a focus lens 106, driving devices 102a, 104a, and 106a, a complementary metal oxide semiconductor (CMOS) element 108, an amplifier integrated correlated double sampling (CDS) circuit 110, an A/D converter 112, an image input controller 114, an imago signal processor 116, a compression processing unit 120, an on screen display (OSD) 121, a liquid crystal display (LCD) driver 120, an LCD 124, a timing generator 126, a central processing unit (CPU) 128, an operation unit 132, a shutter button 133, a memory 134, a video random access memory (VRAM) 136, a media controller 138, a recording medium 140, motor drivers 142a, 142b, and 142c, and a flash 144.

The zoom lens 102 is a lens that is moved forward and backward in an optical axis direction by the driving device 102a to continuously change a magnification of the lens. The driving device 104a opens and doses the iris 104, which is an adjustable aperture that controls the intensity of light incident on the CMOS element 108 at the time of capturing images. The focus lens 106 is moved forward and backward by the driving device 106a in the optical axis direction to control a focus of the subject.

Referring to FIG. 1, only one zoom lens 102 and one focus lens 106 are represented. However, the number of zoom lenses 102 may be two or more and the number of focus lenses 106 may also be two or more in a given image capturing device.

The CMOS 108 is an element that converts light that passes through the zoom lens 102, the iris 104, and the focus lens 106 into an electric signal. In some embodiments, a time of extracting the electric signal may be controlled using an electric shutter. In other embodiments, the time of extracting the electric signal may be controlled using a mechanical shutter. In some embodiments of the present inventive concept, a capturing unit may be constituted by the zoom lens 102, the iris 104, the focus lens 106, and a CCD device. However, the capturing unit is not limited thereto and may not include the zoom lens 102 or the iris 104, for example.

The CDS circuit 110 is a type of sampling circuit that removes noise from the electric signal output by the CMOS element 108. The CDS circuit 110 includes an integrated amplifier that amplifies the electric signal after removing the noise. However, the present inventive concept is not limited thereto. For example, in some embodiments, the CDS circuit and the amplifier may be configured as separate circuits.

The A/D converter 112 converts the electric signal generated by the CMOS element 108 into a digital signal to generate RAW data of an image. RAW is a file format that contains unprocessed digital image information.

The image input controller 114 may control an input in the memory 134 of the RAW data of the image generated by the A/D converter.

The image signal processor 116 may correct the gain of light intensity or adjust the white balance of the electric signal output from the CMOS element 108. The image signal processor 116 acquires exposure data of the captured image. The exposure data may include an auto focus evaluation value (AF evaluation value) and/or an auto exposure (AP) evaluation value. The image signal processor 116 may calculate the AF evaluation value and/or the AE evaluation value.

The compression processing unit 120 may compress an image output by the image signal processor 116 into image data having an appropriate format. A compression format of the image may include a reversible format or an irreversible format. For example, the compression format may be converted into a joint photographic experts group (JPEG) format, a JPEG 2000 format, etc.

The OSD 121 may display a set-up screen of the digital capturing apparatus 100 on the LCD 124. The LCD 124 may display a live view of an image before performing a capturing operation and/or may display various set-up screens of the capturing apparatus 100 or the captured image. However, the present inventive concept is not limited thereto. Image data or various pieces of information of the capturing apparatus 100 may be displayed on the LCD 124 through the LCD driver 122.

The timing generator 126 inputs a timing signal into the CMOS element 108. The shutter speed is determined by the timing signal from the timing generator 126. That is, driving of the CMOS element 108 may be controlled by the timing signal from the timing generator 126. When image light from the subject is incident on the CMOS element 108 While the CMOS element 108 is driven, an electric signal which becomes a basis of the image data may be generated.

The CPU 128 may execute a command of a signal system for the CMOS element 108 or the CDS circuit 110 or execute a command of an operation system for an operation by the operation unit 132. In the embodiment, the capturing apparatus 100 includes only one CPU, and the command of the signal system and the command of the operation system may be executed by different separate CPUs.

The operation unit 132 may operate the capturing apparatus 100 or have a member for performing various set-ups upon capturing. In the member placed in the operation unit 132, a power supply button (not illustrated), a cross key (not illustrated) and a selection button (not illustrated) that select a capturing mode or a capturing drive mode and set a soft focus effect, and the like may be arranged. The shutter button 133, which is used for initiating a capturing operation, may be configured to have a half-pressed state and a fully pressed state. The image capturing apparatus 100 may focus the subject when the shutter button 133 is in a half-pressed state and may capture the subject when the shutter button 133 is in a fully pressed state.

The memory 134 as one example of an image memory unit may temporarily store the captured image or an image synthesized by an image synthesizing unit 118. The memory 134 may have a memory capacity enough to memory a plurality of images. Reading and writing the image in the memory 134 may be controlled by the image input controller 114.

The VRAM 136 holds contents displayed on the LCD 124. The resolution of the LCD 124 and/or the maximum number of colors displayable by the LCD 124 depends on a capacity of the VRAM 136.

The recording medium 140 may record the captured image. Input/output in/from the recording medium 140 may be controlled by a medium controller 138. A memory card, which is a card type memory device that records data in a flash memory, may be used as the recording medium 140.

The motor drivers 142a, 142b, and 142c may control the driving devices 102a, 104a, and 106a that operate the zoom lens 102, the iris 104, and the focus lens 106. The zoom lens 102, the iris 104, and the focus lens 106 are operated by using the motor drivers 142a, 142b, and 142c to control the size of the subject or the intensity of light, and the focus.

The flash 144 may brightly flash the subject upon capturing the subject in an outdoor area at night or a dark place. At the time of performing the flash capturing, an emission command from the CPU 128 is received by the flash 144, and the flash 144 emits light in response to the emission command from the CPU 128. As a result, the subject is illuminated by the light emitted by the flash 144 when the image is captured.

In the examples disclosed herein, the image capturing apparatus 100 includes an exposure system that uses a CMOS image sensor.

The exposure system of the CMOS image sensor may include a rolling shutter system and/or a global shutter system.

In a rolling shutter system, reset, exposure, and reading operations of pixels arranged on the same row are performed simultaneously. The rolling shutter system may be implemented by a simpler operation and a simpler configuration than the global shutter system, and each row of pixels may be selected for reset, exposure and reading sequentially. Further, since a first row may be exposed at the same time a second row is read, it may be easy to increase a frame rate in the rolling shutter system.

However, since data stored in rows are captured at different times in a rolling shutter system, when a target or a camera moves, the resulting image may be distorted. In particular, in high-resolution capturing, when the rolling shutter system is used, a difference in capturing timing by the row increases, and as a result, distortion may be easily increased.

Contrary to this, the global shutter system simultaneously performs the reset and the exposure in all pixels simultaneously. As a result, the image may not be distorted from one row to another. However, in the global shutter system, when additional light is incident at a readout time, an undesired output may be generated.

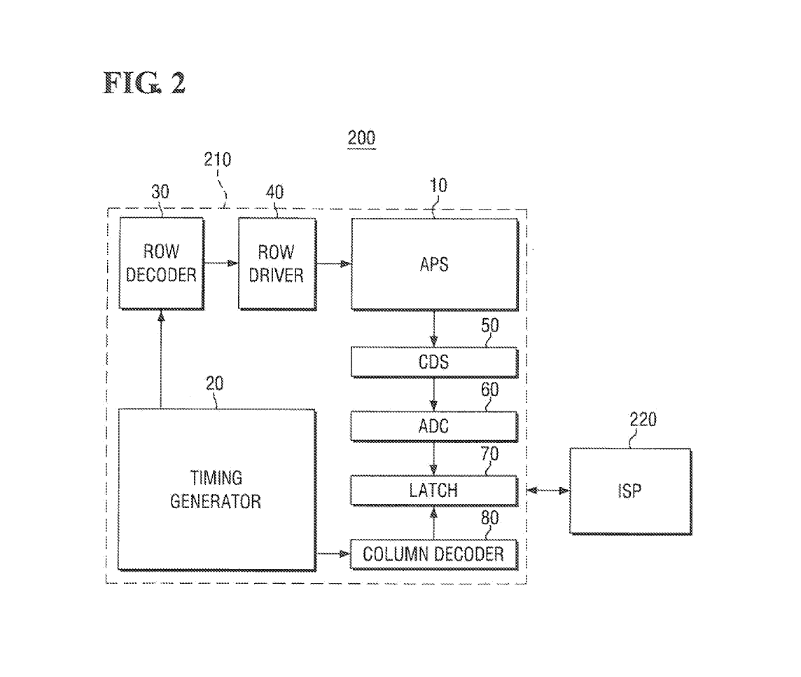

FIG. 2 is a block diagram of an apparatus for capturing images according to another embodiment of the present inventive concept.

Referring to FIG. 2, the image capturing apparatus 200 according to another embodiment of the present inventive concept may include an image sensor 210 and an image signal processor 220. The image sensor 210 includes an active pixel sensor (hereinafter, referred to as APS) array 10 in which pixels including a photoelectric conversion element are arranged two-dimensionally, a timing generator 20, a row decoder 30, a row driver 40, a correlated double sampler (CDS) 50, an analog-to-digital converter (ADC) 60, a latch 70, a column decoder 80, and the like.

The APS array 10 includes a plurality of unit pixels arranged two-dimensionally. The plurality of unit pixels serves to convert an optical image into an electric output signal. The APS array 10 may be driven by receiving a plurality of driving signals including a row selection signal, a reset signal, a charge transmission signal, and the like from the row driver 40. Further, the converted electric output signal may be provided to the correlated double sampler 50 through a vertical signal line. The APS array 10 may include a CMOS type image sensor.

The timing generator 20 may provide a timing signal and a control signal to the row decoder 30 and the column decoder 80.

The row driver 40 may provide a plurality of driving signals for driving the plurality of unit pixels according to a result decoded by the row decoder 30 to the active pixel sensor array 10. In general, when the unit pixels are arranged in the matrix pattern, the driving signal may be provided for each row.

The correlated double sampler 50 receives an output signal formed in the active pixel sensor array 10 through the vertical signal line to hold and sample the received output signal. That is, a specific noise level and a signal level in the output signal are doubly sampled to output a difference level corresponding to a difference between the noise level and the signal level.

The analog-to-digital converter 60 may convert an analog signal corresponding to the difference level into a digital signal and output the converted digital signal.

The latch 70 may latch the digital signal and transmit the latched signal to the image signal processor (ISP) 220 sequentially according to the result decoded by the column decoder 80.

The image signal processor 220 may be formed substantially similarly as the image signal processor 116 described with reference to FIG. 1. The image signal processor 220 may adjust gain correction of the intensity of light or a white balance, for the electric signal output from the image sensor 210. For example, when the capturing is performed by using the global shutter, the image signal processor 220 may receive the exposure data (that is the image signal) of the captured image. Subsequently, the image signal processor 220 may remove the noise included in the received image signal through correction. That is, the image signal processor 220 may remove the undesired output generated upon the capturing using the global shutter through the correction. A detailed description thereof will be made below.

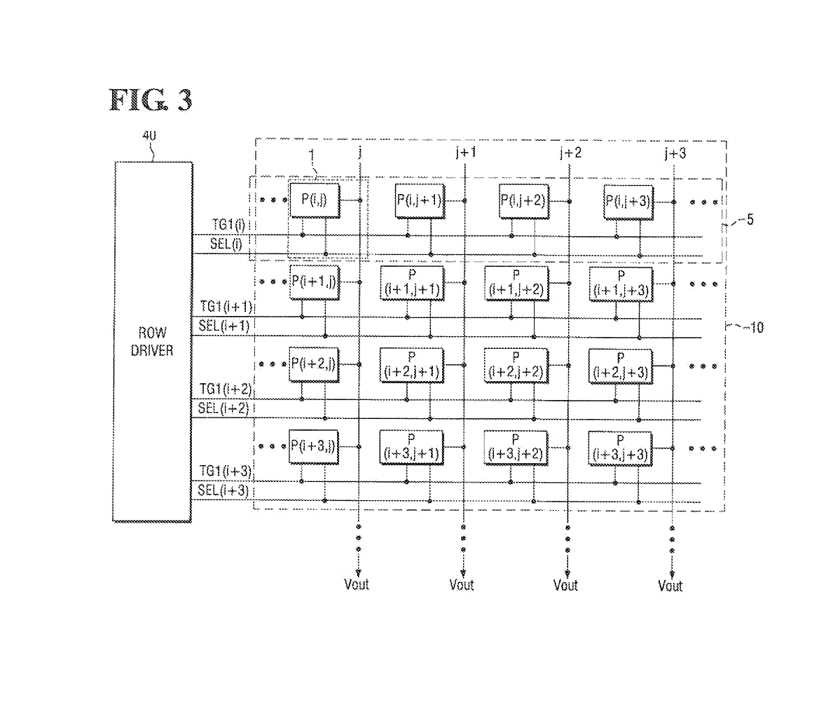

FIG. 3 is a diagram for describing an APS array of FIG. 2.

Referring to FIG. 3, the APS array 10 may include a plurality of active pixels 1. The active pixel 1 may include a CMOS image pixel. The plurality of active pixels may be arranged in the matrix pattern or a row and column pattern P(i, j).

The APS array 10 may include the plurality of active pixels in which the operation of the global shutter is available. Further, the APS array 10 may include a first transfer line TG1 and a selection line SEL connected to the plurality of active pixels, respectively. A plurality of first transfer lines TG1(i) to TG1(i+3) and a plurality of selection lines SEL(i) to SEL(i+3) are arranged for each row of the APS array 10 to be connected with the plurality of active pixels positioned on the same row.

In detail, the plurality of first transfer lines TG1(i) to TG1(i+3) and the plurality of selection lines SEL(i) to SEL(i+3) which are separated from each other for each row may be arrayed in the APS array 10. In the APS array 10, a plurality of column lines j to j+3 separated from each other for each column may be arrayed. For example, when the APS array 10 includes N*M (M and N are integers of two or more) pixels, N first transfer lines TG1, N selection lines SEL, and M column lines j may be arrayed in the APS array 10. However, the present inventive concept is not limited thereto and although not illustrated in FIG. 3, N reset lines RG, N power supply lines VDD, N second transfer lines TG2, and N overflow weight lines OG may also be arrayed in the APS array 10.

The APS array 10 may include N pixel sensor rows 5. The pixel sensor row 5 may include the plurality of adjacent active pixels.

A row address and a row scan of the APS array 10 may be controlled through the first transfer line TG1 and the selection line SEL by the row driver 40. In detail, the row driver 40 may transfer a first driving signal and a second driving signal to the first transfer line TG1 and the selection line SEL, respectively. That is, the row driver 40 may non-sequentially transfer a readout signal to the pixel sensor row 5.

When the image is captured in a global shutter scheme, the first driving signal may be simultaneously transferred to all of the plurality of active pixels and the second driving signal may be non-sequentially transferred to respective rows of the APS array 10. The first driving signal may be transferred earlier than the second driving signal.

For example, the row driver 40 may sequentially transfer a readout signal to all odd-numbered rows among N pixel sensor rows 5 and subsequently, sequentially transfer the readout signal to all even-numbered rows among the N pixel sensor rows 5. The readout signal causes charges stored in the pixels to be converted into an image signal that can be transferred to the image signal processor.

However, the present inventive concept is not limited thereto and the readout signal may be transferred to odd-numbered selection lines among a plurality of selection lines according to a predetermined order and thereafter, the readout signal may be transferred to even-numbered selection lines positioned below the odd-numbered selection lines in the order in which the readout signal is transferred to the odd-numbered selection lines.

The row driver 40 may sequentially transfer the readout signal to a (3n−2)-th (n is a natural number) selection line among the plurality of selection lines, subsequently, sequentially transfer the readout signal to a (3n−1)-th (where n is an even number) selection line among the plurality of selection lines, subsequently, sequentially transfer the readout signal to a 3n-th (where n is a natural number) selection line among the plurality of selection lines, and subsequently, sequentially transfer the readout signal to a (3n−1)-th (where n is an odd number) selection line among the plurality of selection lines. However, the present inventive concept is not limited thereto.

Although not clearly illustrated in the figure, the pixels arranged in the APS array 10 may be arranged in a Bayer pattern or a chess mosaic pattern. When a Bayer pattern technology is adopted, pixels in the active APS array 10 may be arranged to receive red light, green light, and blue light, respectively. However, the spirit of the present inventive concept is not limited thereto and a configuration for a plurality of active pixels arranged in the APS array 10 may be modified in any degree. For example, in some other embodiments of the present inventive concept, the plurality of active pixels arranged in the APS array 10 may be arranged to receive magenta (Mg) light, yellow (Y) light, cyan (Cy) light, and/or white (W) light.

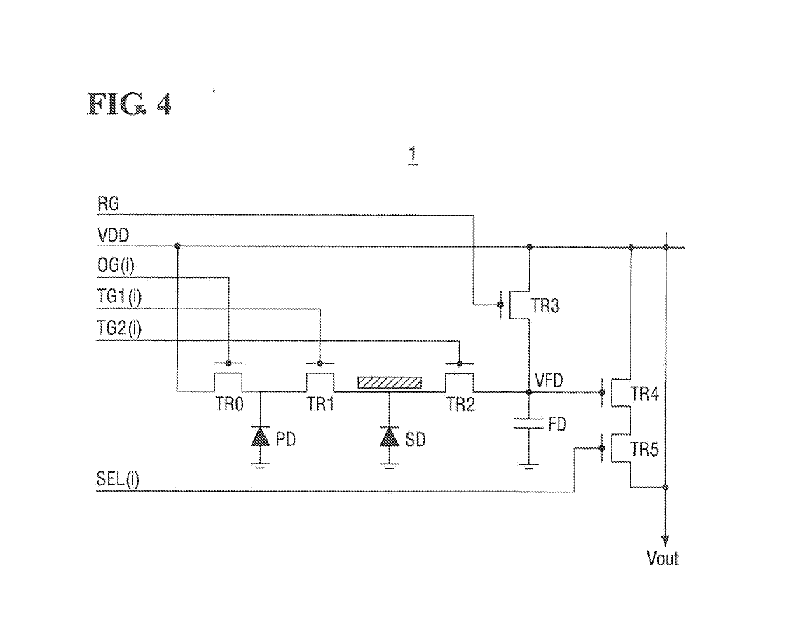

FIG. 4 is a circuit diagram for describing the structure of active pixels included in the APS array of FIG. 3.

Referring to FIG. 4, the active pixel 1 included in the APS array 10 may include a photo diode PD, a storage diode SD, an overflow transistor TR0, a first transfer transistor TR1, a second transfer transistor TR2, a reset transistor TR3, a drive transistor TR4, and a select transistor TR5. Hereinafter, a pixel having a 6-transistor structure is described as an example as illustrated in FIG. 4, but the present inventive concept is not limited thereto. Unlike this, the structure of the pixel may be transformed to a 3-transistor structure, a 4-transistor structure, a 5-transistor structure, and the like in any degree.

The photo diode PD as a light receiver that receives an external optical image may generate a photocharge in proportion to incident light. Although the first photo diode PD is illustrated as an example of the light receiver in FIG. 4, the present inventive concept is not limited thereto and a form of the light receiver may be transformed in any degree. The photo diode PD may be connected between the transfer transistor TR1 and a ground terminal GND or between the overflow transistor TR0 and the ground terminal GND.

The overflow transistor TR0 may prevent an overflow from being generated in the photo diode PD. The overflow transistor TR0 may have a specific weight value, and as a result, prevent the overflow from being generated in the photo diode PD. However, the present inventive concept is not limited thereto. The overflow transistor TR0 may receive a control signal from the row driver 40 of FIG. 2 through the overflow weight line OG.

The first transfer transistor TR1 may transfer the photocharge generated by the photo diode to the storage diode SD. The first transfer transistor TR1 may receive the control signal from the row driver 40 of FIG. 2 through the first transfer line. That is, when the first driving signal is input through the first transfer line TG1(i) (herein, since the active pixel P(i, j) of FIG. 3 is arranged on an i row, the first driving signal for the i row is provided to the active pixel P(i, j) of FIG. 3), the first transfer transistor TR1 may transfer the photocharge generated by the photo diode PD to the storage diode SD.

To this end, in the first transfer transistor TR1, a drain terminal may be connected to the storage diode SD, a source terminal may be connected to the photo diode PD, and a gate terminal may be connected to the row driver 40 of FIG. 2. When the first driving signal is provided from the row driver 40 of FIG. 2, the first transfer transistor TR1 is turned on, and as a result, an output of the photo diode PD may be provided to the storage diode SD.

In the global shutter scheme, the first driving signal is simultaneously transferred to the plurality of first transfer lines TG1(i), and as a result, photocharges of the plurality of photo diodes PD generated at a specific moment may move to the storage diode SD at once.

The storage diode SD may temporarily store the photocharges generated by the photo diode PD. Although the first photo diode PD is illustrated as an example of the light receiver in FIG. 4, the present inventive concept is not limited thereto and a form of the light receiver may be transformed in any degree. For example, the storage diode SD may be a capacitor.

A metal material or a tungsten material may be arranged around the storage diode SD. The material is used for preventing photocharges from additionally being input from the outside while the photocharges are temporarily stored in the storage diode SD. The additionally input photocharges may become a noise component that changes the quantity of the photocharges transferred from the photo diode PD.

In another method for preventing the photocharges from being additionally input, electrons which move into the storage diode SD may be blocked by doping. As a result, the storage diode SD may have lower sensitivity than the photo diode PD.

However, in spite of the method that arranges the metal material or uses the doping, a problem in which the noise component is added into the storage diode SD may occur. The noise component may be removed by the image signal processor 220 described with reference to FIG. 2. A method for removing the noise component will be described below in detail.

The second transfer transistor TR2 may serve to transfer the photocharge generated by the photo diode PD to a gate terminal of the drive transistor TR4 through a floating diffusion node FD. To this end, in the second transfer transistor TR2, a drain terminal may be connected to the floating diffusion node FD, a source terminal may be connected to the storage diode SD, and a gate terminal may be connected to the row driver 40 of FIG. 2. When the control signal is provided from the row driver 40 of FIG. 2 through the second transfer line TG2(i), the second transfer transistor TR2 is turned on, and as a result, an output of the storage diode SD may be provided to the floating diffusion node FD.

The reset transistor TR3 may apply reset voltage to the gate terminal of the drive transistor TR4. To this end, in the reset transistor TR3, a drain terminal may be connected to a drive power supply terminal VDD, a source terminal may be connected to the floating diffusion node FD, and a gate terminal may be connected to the row driver 40 of FIG. 2. When a reset control signal RG is provided from the row driver 40 of FIG. 2, the reset transistor TR3 is turned on, and as a result, an output of the power supply terminal VDD may be provided to the gate terminal of the drive transistor TR4. When the output of the power supply terminal VDD is provided to the gate terminal of the drive transistor TR4 as described above, the drive transistor TR4 is fully turned on, and as a result, the output of the drive transistor TR4 may be reset.

The drive transistor TR4 generates source-drain current in proportion to the intensity of the photocharge applied to the gate terminal. In detail, floating diffusion voltage VFD proportional to the intensity of the photocharge generated from the photo diode PD is generated in the floating diffusion node FD and the floating diffusion voltage VFD is applied to the gate terminal of the drive transistor TR4, and as a result, the source-drain current proportional to the intensity of the photocharge may be generated.

For such an operation, in the drive transistor TR4, a terminal may be connected to the power supply terminal VDD, a source terminal may be connected to a drain terminal of the select transistor TR5, and a gate terminal may be connected to the floating diffusion node FD which is a common terminal of the drain terminal of the transfer transistor TR1 and a source terminal of the reset transistor TR3.

The select transistor TR5 may transfer the current generated from the drive transistor TR4 to a column line Vout. To this end, in the select transistor TR5, a drain terminal may be connected to the source terminal of the drive transistor TR4, a source terminal may be connected to the column line Vout, and a gate terminal may be connected to the selection line SEL(i).

By such a configuration, the select transistor TR5 is gated to a signal applied to the selection line SEL(i) (herein, since the active pixel P(i, j) of FIG. 3 is arranged on the i row, the second driving signal for the i row is provided to the active pixel P(i, j) of FIG. 3 to output the source-drain current (herein, this may be the image signal) generated by the drive transistor TR4 to the column line Vout. The image signal output to the column line Vout may be provided to the image signal processor 220. However, the present inventive concept is not limited thereto.

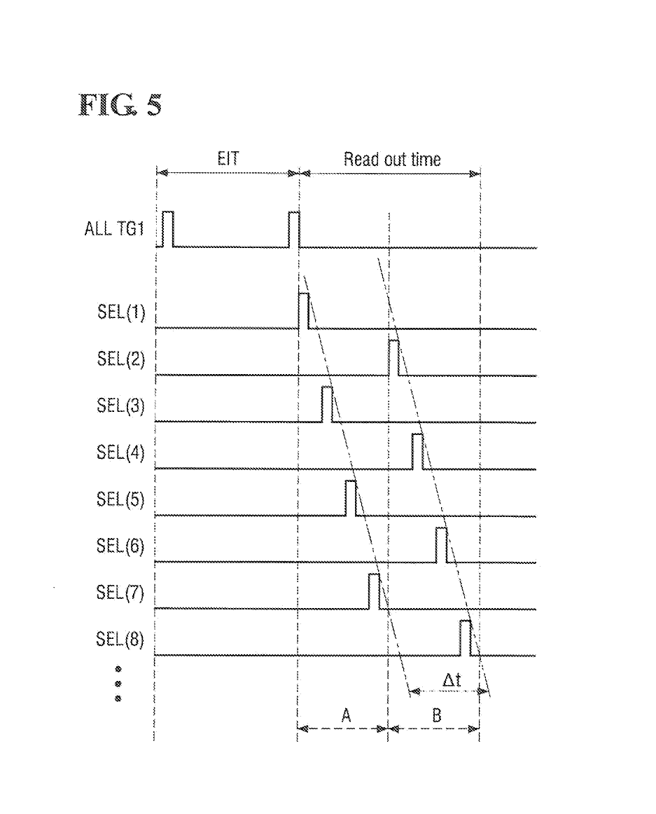

FIG. 5 is a timing diagram for describing a signal input in an image sensor according to an embodiment of the present inventive concept.

Referring to FIGS. 3 and 5, the first driving signal is simultaneously provided to all of the first transfer lines TG1 of the APS array 10 at the first part of an effective integration time (EIT) interval. Therefore, photocharge values in the photo diodes PD of all of the active pixels 1 in the APS array 10 may be initialized. Subsequently, at the last part of the EIT interval, the first driving signal is simultaneously provided to all of the first transfer lines TG1 once again. That is, the first driving signal may be simultaneously transferred to all of the plurality of active pixels.

Therefore, all of the photo diodes PD in the APS array 10 may receive an external optical image at a specific moment. Subsequently, photocharges corresponding to the received external optical image may be simultaneously moved to and stored in the storage diodes SD. In a subsequent process, the photocharges stored in the storage diodes SD are converted into the image signal to be transferred to the image signal processor 220 when the second driving signal (hereinafter, referred to as the readout signal) transferred through the selection line SEL is input. The readout signal may be non-sequentially transferred to the respective rows of the APS array 10. The readout signal means a signal in which a high level (hereinafter, the high level represents a logical high level) state is provided for a predetermined time and thereafter, the high level state is changed to a low level (hereinafter, the low level represents a logical low level) state. That is, the readout signal may be input in a pulse form. However, the present inventive concept is not limited thereto.

During an A interval, the row driver 40 may sequentially transfer the readout signal to all odd-numbered rows among N pixel sensor rows 5 of the APS array 10. For example, the readout signal may be input into a first row, subsequently, the readout signal may be input into a third row, subsequently, the readout signal may be input into a fifth row, and subsequently, the readout signal may be input into a seventh row. However, the present inventive concept is not limited thereto. Therefore, the image signal processor 220 may sequentially receive the image signal for the odd-numbered rows.

The high level state of the readout signal of the first row and the high level state of the readout signal of the third row sequentially input may not be overlapped with each other. However, the present inventive concept is not limited thereto and the high level state of the readout signal of the first row and the high level state of the readout signal of the third row may be overlapped with each other for a predetermined time.

During a subsequent B interval, the row driver 40 may sequentially transfer the readout signal to all even-numbered rows among N pixel sensor rows 5 of the APS array 10. For example, subsequently to the readout signal of the odd-numbered row which is input last, the readout signal may be input into a second row, subsequently, the readout signal may be input into a fourth row, subsequently, the readout signal may be input into a sixth row, and subsequently, the readout signal may be input into an eighth row. However, the present inventive concept is not limited thereto. Therefore, the image signal processor 220 may sequentially receive the image signal for the even-numbered rows subsequently to the odd-numbered rows.

When the signal received by the image signal processor 220 is analyzed, the image signal processor 220 may receive the signals of an odd-numbered row and an even-numbered row which are adjacent to each other at a predetermined time interval Δt. The image signal processor 220 may remove the noise of the image signal by using the image signals non-sequentially output from the adjacent pixel sensor rows 5.

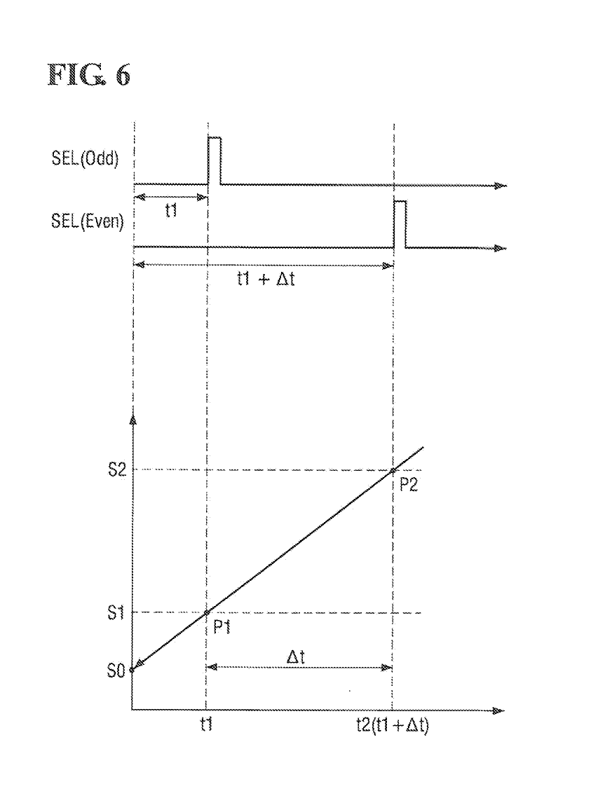

FIG. 6 is a diagram for describing an operation of an image signal processing processor according to an embodiment of the present inventive concept.

Referring to FIG. 6, the image signal processor 220 applies a linear model to the odd-numbered row and the even-numbered row of the APS array 10, which are adjacent to each other to correct the image signals output from the odd-numbered row and the even-numbered row.

As the photocharges stored in the storage diode SD are stored longer, the quantity of photocharges corresponding to noise input from the outside increases. Accordingly, the image signal of the odd-numbered row which is first read out may have less noise than the image signal of the even-numbered row which is read out later. The reason is that the noise may linearly increase in proportion to the time when the photocharges are stored in the storage diode SD.

Therefore, when a first coordinate P1 corresponding to a time t1 when the odd-numbered row is read out and the size S1 of the image signal transferred to the image signal processor 220 and a second coordinate P2 corresponding to a time t2(t1+Δt) when the even-numbered row is read out and the size S2 of the image signal transferred to the image signal processor 220 are substituted into the linear model, an original image signal S0 without the noise component may be acquired. In detail, the original image signal S0 may be acquired by correcting the image signals S1 and S2 through Equations 1 and 2.

Corrected S1(=S0)=S1−(S2−S1)/(Δt)*t1 [Equation 1]

Corrected S2(=S0)=S2−(S2−S1)/(Δt)*(t1+Δt) [Equation 2]

In the equations, S1 represents the size of the image signal of the odd-numbered row transferred to the image signal processor 220, S2 represents the size of the image signal of the even-numbered row transferred to the image signal processor 220, S0 represents an image signal before noise is mixed, t1 represents a time when the odd-numbered row is read out, t2 represents a time when the even-numbered row is read out and Δt represents an interval t2−t1 between the time when the odd-numbered row is read out and the time when the even-numbered row is read out.

The image signal processor 220 may perform correction of removing the noise component included in the input image signal by using the linear model and Equations 1 and 2.

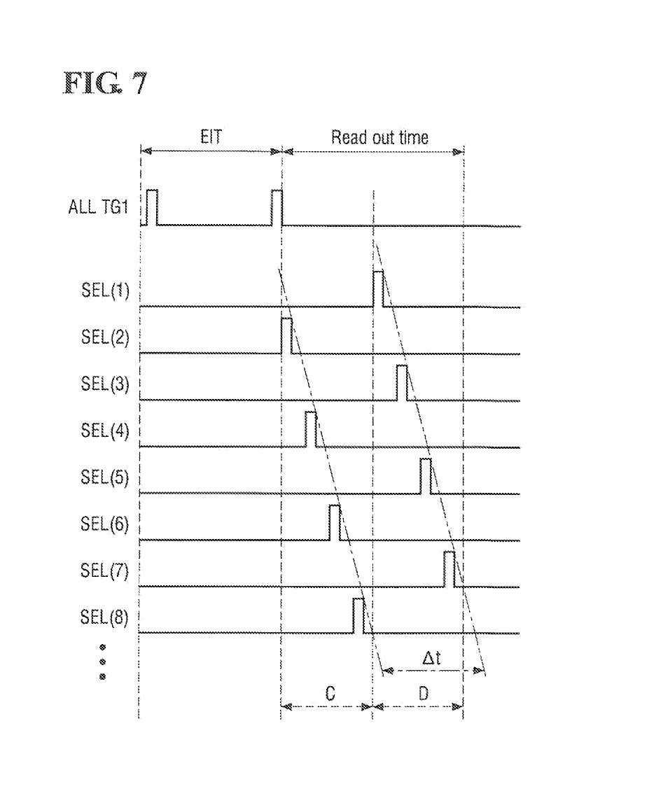

FIG. 7 is a timing diagram for describing a signal input in an image sensor according to another embodiment of the present inventive concept. For easy description, hereinafter, a duplicated description of the same matter as the aforementioned embodiment will be omitted and a difference from the aforementioned embodiment will be primarily described.

Referring to FIGS. 3 and 7, the first driving signal is simultaneously provided to all of the first transfer lines TG1 of the APS array 10 at the first part of the EIT interval. Subsequently, at the last part of the EIT interval, the first driving signal is simultaneously provided to all of the first transfer lines TG1 once again. Therefore, all of the photo diodes PD in the APS array 10 may receive an external optical image at a specific moment. Subsequently, photocharges corresponding to the received external optical image may be simultaneously moved to and stored in the storage diode SD. In a subsequent process, the photocharges stored in the storage diode SD are converted into the image signal to be transferred to the image signal processor 220 when the readout signal transferred through the selection line SEL is input.

During a C interval, the row driver 40 may sequentially transfer the readout signal to all even-numbered rows among N pixel sensor rows 5 of the APS array 10. For example, the readout signal may be input into a second row, subsequently, the readout signal may be input into a fourth row, subsequently, the readout signal may be input into a sixth row, and subsequently, the readout signal may be input into an eighth row. However, the present inventive concept is not limited thereto. Therefore, the image signal processor 220 may sequentially receive the image signals for the even-numbered rows.

During a subsequent D interval, the row driver 40 may sequentially transfer the readout signal to all odd-numbered rows among N pixel sensor rows 5 of the APS array 10. For example, subsequently to the readout signal of the even-numbered row which is input last, the readout signal may be input into a first row, subsequently, the readout signal may be input into a third row, subsequently, the readout signal may be input into a fifth row, and subsequently, the readout signal may be input in the seventh row. However, the present inventive concept is not limited thereto. Therefore, the image signal processor 220 may sequentially receive the image signals for the odd-numbered rows subsequently to the even-numbered rows.

When the signal received by the image signal processor 220 is analyzed, the image signal processor 220 may receive the image signals for an even-numbered row and an odd-numbered row which are adjacent to each other at a predetermined time interval Δt. The image signal processor 220 may remove the noise of the image signal by using the image signals non-sequentially output from the adjacent pixel sensor rows 5.

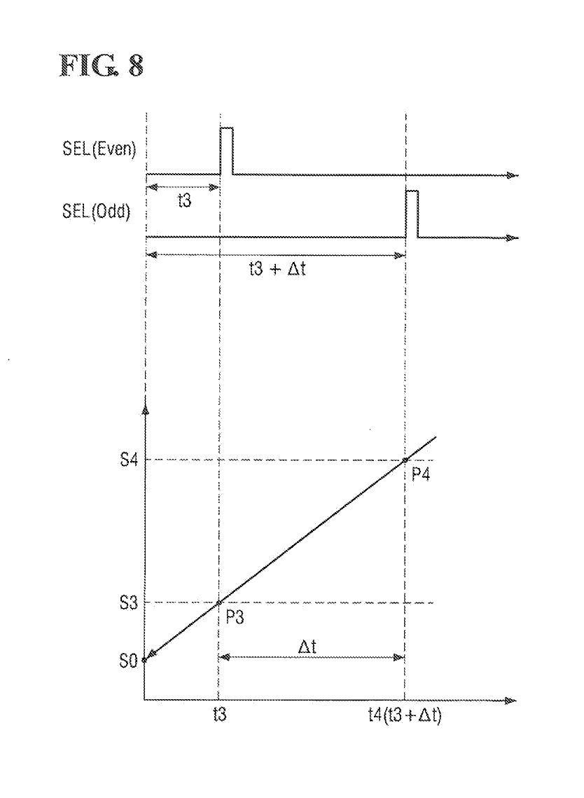

FIG. 8 is a diagram for describing an operation of an image signal processor 220 according to another embodiment of the present inventive concept. For easy description, hereinafter, a duplicated description of the same matter as the aforementioned embodiment will be omitted and a difference from the aforementioned embodiment will be primarily described.

Referring to FIG. 8, the image signal processor 220 applies a linear model to the even-numbered row and the odd-numbered row of the APS array 10, which are adjacent to each other to correct the image signals output from the even-numbered row and the odd-numbered row.

Therefore, when a third coordinate P3 corresponding to a time t3 when the even-numbered row is read out and the size S3 of the image signal transferred to the image signal processor 220 and a fourth coordinate P4 corresponding to a time t4(t3+Δt) when the odd-numbered row is read out and the size S4 of the image signal transferred to the image signal processor 220 are substituted into the linear model, the original image signal S0 without the noise component may be acquired. In detail, the original image signal S0 may be acquired by correcting the image signals S3 and S4 through Equations 3 and 4.

Corrected S3(=S0)=S3−(S4−S3)/(Δt)*t3 [Equation 3]

Corrected S4(=S0)=S3−(S4−S3)/(Δt)*(t3+Δt) [Equation 4]

In the equations, S3 represents the size of the image signal of the odd-numbered row transferred to the image signal processor 220, S4 represents the size of the image signal of the even-numbered row transferred to the image signal processor 220, S0 represents an image signal before noise is mixed, t3 represents a time when the even-numbered row is read out, t4 represents a time when the odd-numbered row is read out, and Δt represents an interval t4−t3 between the time when the even-numbered row is read out and the time when the odd-numbered row is read out.

The image signal processor 220 may perform correction of removing the noise component included in the input image signal by using the linear model and Equations 3 and 4.

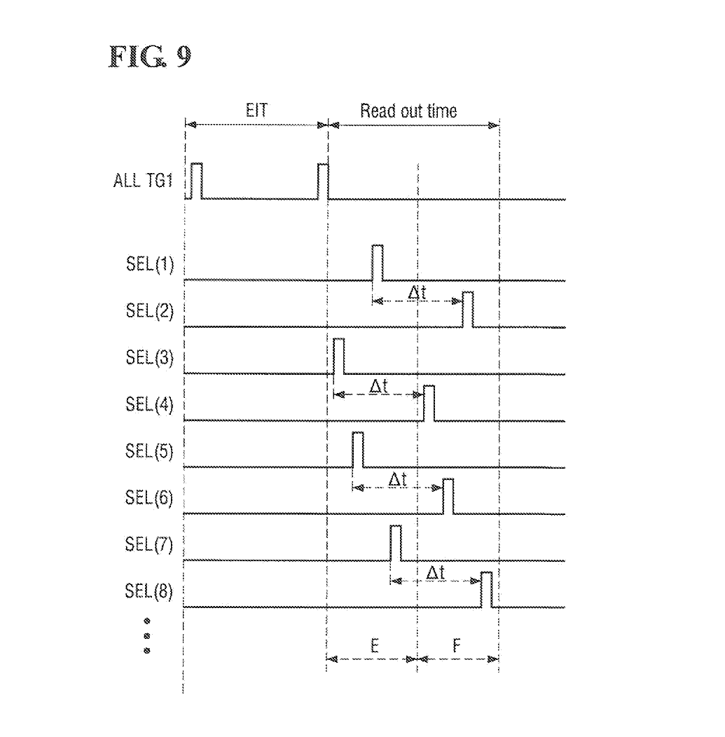

FIG. 9 is a timing diagram for describing a signal input in an image sensor according to yet another embodiment of the present inventive concept. For easy description, hereinafter, a duplicated description of the same matter as the aforementioned embodiment will be omitted and a difference from the aforementioned embodiment will be primarily described.

Referring to FIGS. 3 and 9, the first driving signal is simultaneously provided to all of the first transfer lines TG1 of the APS array 10 at the first part of an EIT interval. Subsequently, at the last part of the EIT interval, the first driving signal is simultaneously provided to all of the first transfer lines TG1 once again. Therefore, all of the photo diodes PD in the APS array 10 may receive an external optical image at a specific moment, Subsequently, photocharges corresponding to the received external optical image may be simultaneously moved to and stored in the storage diode SD. In a subsequent process, the photocharges stored in the storage diode SD are converted into the image signal to be transferred to the image signal processor 220 when the readout signal transferred through the selection line SEL is input.

During an E interval, the row driver 40 may transfer the readout signal to all odd-numbered rows among N pixel sensor rows 5 of the APS array 10 according to a predetermined order. For example, the readout signal may be input into a third row, subsequently, the readout signal may be input into a fifth row, subsequently, the readout signal may be input into a first row, and subsequently, the readout signal may be input into a seventh row. However, the present inventive concept is not limited thereto.

The predetermined order corresponds to an arbitrary order determined by a user, but the present inventive concept is not limited thereto and all the odd-numbered rows may be read out according to an order randomly formed by using a random number. Therefore, the image signal processor 220 may receive the image signals for the odd-numbered rows according to the predetermined order.

During a subsequent F interval, the row driver 40 may receive image signals for even-numbered rows positioned below the odd-numbered rows in the order of receiving the image signals for the odd-numbered rows among N pixel sensor rows 5 of the APS array 10. For example, subsequently to the readout signal of the odd-numbered row which is input last, the readout signal may be input in the row positioned below the third row corresponding to the first odd-numbered row in the predetermined order, subsequently, the readout signal may be input in the sixth row, subsequently, the readout signal may be input in the second row, and subsequently the readout signal may be input in the eighth row. However, the present inventive concept is not limited thereto. Therefore, the image signal processor 220 may receive the image signals for the even-numbered rows subsequently to the odd-numbered rows according to the predetermined order.

When the signal input by the image signal processor 220 is analyzed, the image signal processor 220 may receive the image signals for an odd-numbered row and an even-numbered row positioned below the odd-numbered row at a predetermined time interval Δt. The image signal processor 220 may remove the noise of the image signal by using the image signals output from the adjacent pixel sensor rows 5 according to the predetermined order.

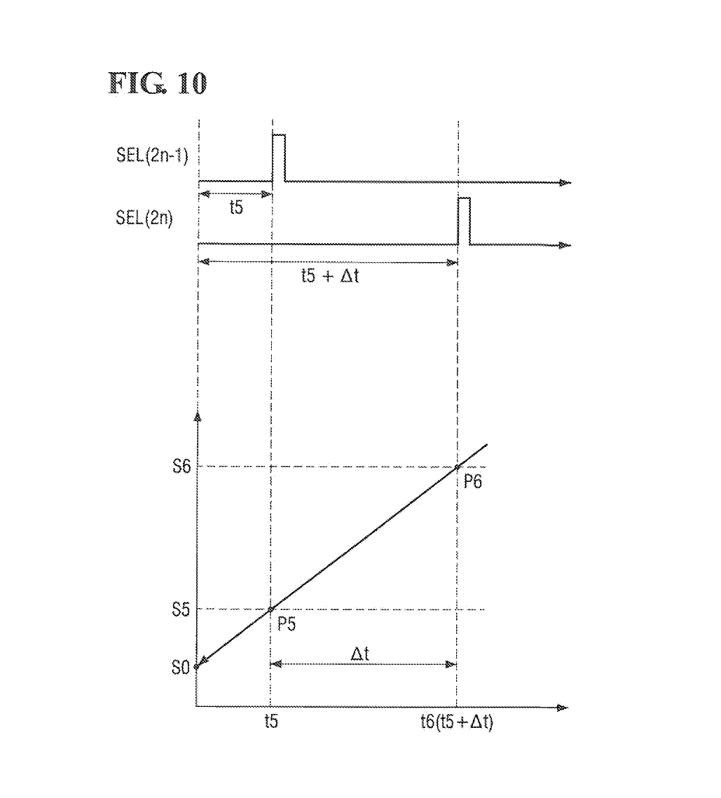

FIG. 10 is a diagram for describing an operation of an image signal processor 220 according to still another embodiment of the present inventive concept. For easy description, hereinafter, a duplicated description of the same matter as the aforementioned embodiment will be omitted and a difference from the aforementioned embodiment will be primarily described.

Referring to FIG. 10, the image signal processor 220 applies the linear model to an odd-numbered row 2n−1 (n is a natural number) and an even-numbered row 2n (n is the natural number) which are adjacent to each other in the APS array 10 to correct image signals output from the odd-numbered row 2n−1 and the even-numbered row 2n.

When a fifth coordinate P5 corresponding to a time t5 when the odd-numbered row 2n−1 is read out and the size S5 of the image signal transferred to the image signal processor 220 and a sixth coordinate P6 corresponding to a time t6(t5+Δt) when the even-numbered row 2n is read out and the size S6 of the image signal transferred to the image signal processor 220 are substituted into the linear model, the original image signal S0 without the noise component may be acquired. In detail, the original image signal S0 may be acquired by correcting the image signals S5 and S6 through Equations 5 and 6.

Corrected S5(=S0)=S5−(S6−S5)/(Δt)*t5 [Equation 5]

Corrected S6(=S0)=S5−(S6−S5)/(Δt)*(t5+Δt) [Equation 6]

In the equations, S5 represents the size of the image signal of the odd-numbered row 2n−1 transferred to the image signal processor 220, S6 represents the size of the image signal of the even-numbered row 2n positioned below the odd-numbered row 2n−1 transferred to the image signal processor 220, S0 represents an image signal before noise is mixed, t5 represents a time when the odd-numbered row 2n-1 is read out, t6 represents a time when the even-numbered row 2n is read out, and Δt represents an interval t6−t5 between the time when the odd-numbered row 2n−1 is read out and the time when the even-numbered row 2n is read out.

The image signal processor 220 may perform correction of removing the noise component included in the input image signal by using the linear model and Equations 5 and 6. The correction method of the image signal processor 220 according to still another embodiment of the present inventive concept may be used when a signal corresponding to noise has a gradient. However, the present inventive concept is not limited thereto.

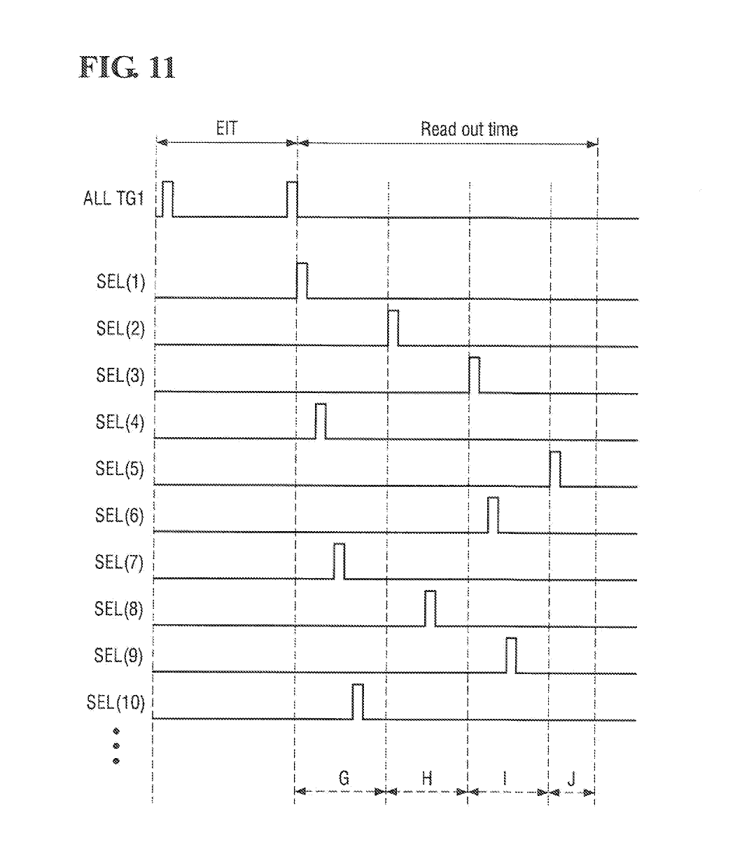

FIG. 11 is a timing diagram for describing a signal input in an image sensor according to still another embodiment of the present inventive concept. For easy description, hereinafter, a duplicated description of the same matter as the aforementioned embodiment will be omitted and a difference from the aforementioned embodiment will be primarily described.

Referring to FIGS. 3 and 11, the first driving signal is simultaneously provided to all of the first transfer lines TG1 of the APS array 10 at the first part of an EIT interval. Subsequently, at the last part of the EIT interval, the first driving signal is simultaneously provided to all of the first transfer lines TG1 once again. Therefore, all of the photo diodes PD in the APS array 10 may receive an external optical image at a specific moment. Subsequently, photocharges corresponding to the received external optical image may be simultaneously moved to and stored in the storage diode SD. In a subsequent process, the photocharges stored in the storage diode SD are converted into the image signal to be transferred to the image signal processor 220 when the readout signal transferred through the selection line SEL is input.

During a G interval, the row driver 40 may sequentially transfer the readout signal to (3n−2)-th (where n is a natural number) rows among N pixel sensor rows 5 of the APS array 10. For example, the readout signal may be input into a first row, subsequently, the readout signal may be input into a fourth row, subsequently, the readout signal may be input into a seventh row, and subsequently, the readout signal may be input into a tenth row.

During a subsequent H interval, the row driver 40 may sequentially transfer the readout signal to (3n−1)-th (where n is an odd number) rows among N pixel sensor rows 5 of the APS array 10. For example, subsequently to the readout signal of the (3n−2)-th (where n is a natural number) row which is input last, the readout signal may be input into a second row and subsequently, the readout signal may be input into an eighth row.

During a subsequent I interval, the row driver 40 may sequentially transfer the readout signal to 3n-th (where n is the natural number) rows among N pixel sensor rows 5 of the APS array 10. For example, subsequently to the readout signal of the 3n−1-th (n is the natural number) row Which is input last, the readout signal may be input into a third row, the readout signal may be input into a sixth row, and subsequently, the readout signal may be input into a ninth row.

During a subsequent I interval, the row driver 40 may sequentially transfer the readout signal to the (3n−1)-th (where n is an even number) rows among N pixel sensor rows 5 of the APS array 10. For example, subsequently to the readout signal of the 3n-th (n is the natural number) row which is input last, the readout signal may be input in a fifth row.

Therefore, the image signal processor 220 may sequentially receive the image signal for an (3n−2)-th (where n is a natural number) row among the N pixel sensor rows 5, subsequently, sequentially receive the image signal for the (3n−1)-th (where n is an odd number) row, subsequently, sequentially receive the image signal for the 3n-th (here n is a natural number) row, and subsequently, sequentially receive the image signal for the (3n−1)-th (where n is an even number) row. However, the present inventive concept is not limited thereto and the readout signal may be non-sequentially input in three or more adjacent pixel sensor rows 5.

When the signal received by the image signal processor 220 is analyzed, the image signal processor 220 may receive the non-sequential image signals for three adjacent pixel sensor rows 5. The image signal processor 220 may remove the noise of the image signal by using the image signals of three adjacent pixel sensor rows 5.

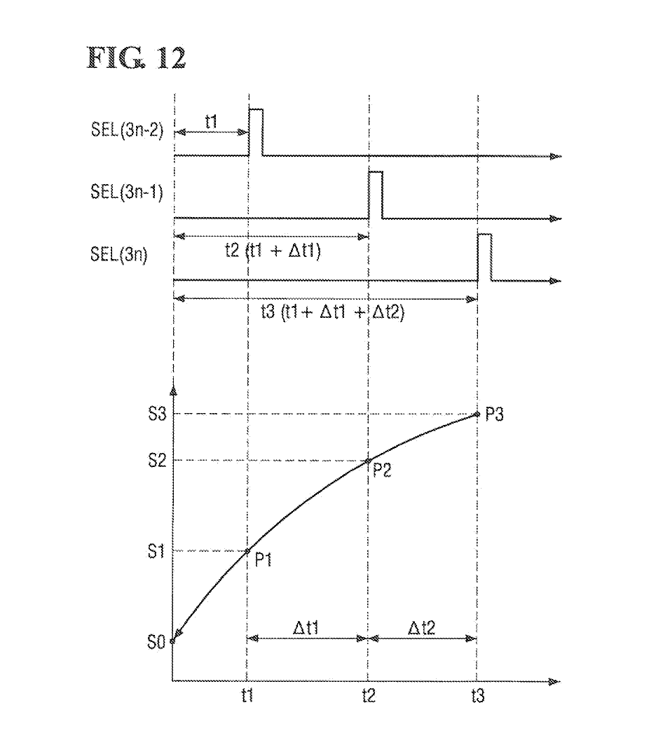

FIG. 12 is a diagram for describing an operation of an image signal processor 220 according to still another embodiment of the present inventive concept. For easy description, hereinafter, a duplicated description of the same matter as the aforementioned embodiment will be omitted and a difference from the aforementioned embodiment will be primarily described.

Referring to FIG. 12, the image signal processor 220 may correct the output image signal by applying a log function model or an exponential function model to three adjacent pixel sensor rows 5 among N pixel sensor rows 5 of the APS array 10.

When a first coordinate P1 corresponding to a time t1 when a first row 3n−2 is read out and the size S1 of the image signal transferred to the image signal processor 220, a second coordinate P2 corresponding to a time t2(t1+Δt1) when a second row 3n−1 is read out and the size S2 of the image signal transferred to the image signal processor 220, and a third coordinate P3 corresponding to a time t3(t1+Δt1+Δt2) when a third row 3n is read out and the size S3 of the image signal transferred to the image signal processor 220 are substituted into the log function model or the exponential function model, the original image signal S0 without the noise component may be acquired. That is, the original image signal S0 may be acquired through the log function model or the exponential function model that links the first to third coordinates P1 to P3. Δt1 represents an interval t2−t1 between the time t2 when, the second row 3n−1 is read out and the time t1 when the first row 3n−2 is read out. Δt2 represents an interval t3−t2 between the time t3 when the third row 3n is read out and the time t2 when the second row 3n−1 is read out. Δt1 and Δt2 may be different from each other. However, the present inventive concept is not limited thereto.

The correction method of the image signal processor 220 according to still another embodiment of the present inventive concept may be used when a signal corresponding to noise has a gradient. However, the present inventive concept is not limited thereto.

Through the correction of the image signal processor 220 according to some embodiments of the present inventive concept, when additional light is incident at the readout time of the global shutter system, a problem in which an undesired output occurs may be solved.

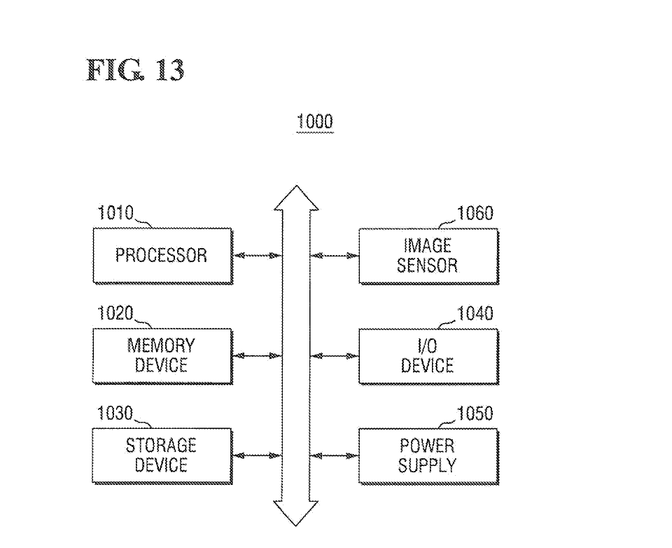

FIG. 13 is a block diagram illustrating an example in which the apparatus for capturing images according to the embodiments of the present inventive concept is applied to a computing system.

Referring to FIG. 13, the computing system 1000 may include a processor 1010, a memory device 1020, a storage device 1030, an input/output device 1040, a power supply 1050, and an image sensor 1060.

Herein, as the image sensor 1060, the image sensor 210 according to the embodiments of the present inventive concept may be used. Meanwhile, although not illustrated in FIG. 13, the computing system 1000 may further include ports which may communicate with a video card, a sound card, a memory card, a USB device, and the like or other electronic devices.

The processor 1010 may perform specific calculations or tasks. Herein, the processor 1010 may include the image signal processor 220 according to the embodiments of the present inventive concept. In some embodiments, the processor 1010 may be a micro-processor and a central processing unit (CPU).

The processor 1010 may communicate with the memory device 1020, the storage device 1030, and the input/output device 1040 through an address bus, a control bus, and a data bus.

In some embodiments, the processor 1010 may be connected even to an extension bus such as a peripheral component interconnect (PCI) bus.

The memory device 1020 may store data required for operating the computing system 1000.

For example, the memory device 1020 may be implemented by a DRAM, a mobile DRAM, an SRAM, a PRAM, an FRAM, an RRAM, and/or an MRAM. The storage device 1030 may include a solid state drive (SSD), a hard disk drive (HDD), a CD-ROM, and the like.

The input/output device 1040 may include input means such as a keyboard, a keypad, a mouse, and the like and output means such as a printer and a display. The power supply 1050 may supply operating voltage required for operating the computing system 1000.

The image sensor 1060 is connected to and communicates with the processor 1010 through buses or other communication links. The image sensor 1060 may be integrated in one chip together with the processor 1010 or integrated in a different chip from that of the processor 1010.

Herein, the computing system 1000 should be analyzed as all computing systems using the image sensor. For example, the computing system 1000 may include a digital camera, a mobile phone, a personal digital assistant (PDA), a portable multimedia player (PMP), a smart phone, a tablet PC, and the like.

In some embodiments of the present inventive concept, the computing system 1000 may include an ultra mobile PC (UMPC), a workstation, a net-book, a portable computer, a wireless phone, a mobile phone, an e-book, a portable game machine, a navigation device, a black box, a 3-dimensional television, a digital audio recorder, a digital audio player, a digital picture recorder, a digital picture player, a digital video recorder, a digital video player, and the like.

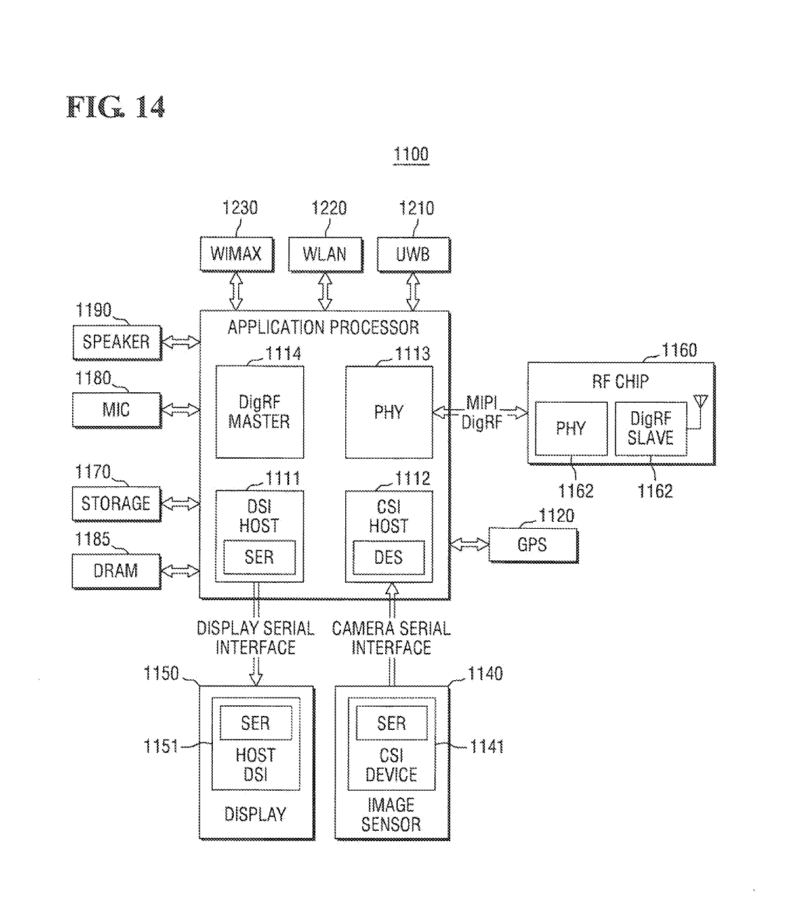

FIG. 14 is a block diagram illustrating one example of an interface used in the computing system of FIG. 13.

Referring to FIG. 14, the computing system 1100 may be implemented by a data processor capable of using or supporting an MIPI interface and include an application processor 1110, an image sensor 1140, and a display 1150.

A CSI host 1112 of the application processor 1110 may perform serial communication with a camera serial interface (CSI) device 1141 of the image sensor 1140 through a CSI.

In some embodiments of the present inventive concept, the CSI host 1112 may include a deserializer DES and the CSI device 1141 may include a serializer SER. A DSI host 1111 of the application processor 1110 may perform serial communication with a display serial interface (DSI) device 1151 of the display 1150 through a DSI.

In some embodiments of the present inventive concept, the DSI host 1111 may include the serializer SER and the DSI device 1151 may include the deserializer DES. Moreover, the computing system 1100 may further include a radio frequency (RF) chip 1160 capable of communicating with the application processor 1110. A PHY 1113 of the computing system 1100 and a PHY 1161 of the RF chip 1160 may perform data transmission and reception according to a mobile industry processor interface (MIPI) DigRF.

The application processor 1110 may further include a DigRF MASTER 1114 that controls data transmission and reception according to the MIPI DigRF of the PHY 1161. Meanwhile, the computing system 1100 may include a global positioning system (GPS) 1120, a storage 1170, a microphone 1180, a dynamic random access memory (DRAM) 1185, and a speaker 1190. Further, the computing system 1100 may perform communication by using an ultra wideband (UWB) 1210, a wireless local area network (WLAN) 1220, and a worldwide interoperability for microwave access (WIMAX) 1230. However, the structure and the interface of the computing system 1100 is one example and the present inventive concept is not limited thereto.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. An apparatus for capturing images, the apparatus comprising:
an active pixel sensor (APS) array including a plurality of active pixels each including a photo diode and a storage diode, the plurality of active pixels being arranged in an N×M array (where N and M are natural numbers of 2 or more); and
an image signal processor that is configured to correct an image signal output by the APS array;
wherein the APS array includes N pixel sensor rows; and
wherein the image signal processor removes noise from the image signal by using image signals that are sequentially output from non-adjacent pixel sensor rows in the APS array.

2. The apparatus of claim 1, further comprising:
a row driver that sequentially transfers a readout signal to the non-adjacent ones of the pixel sensor rows,
wherein the row driver sequentially transfers the readout signal to all odd-numbered rows from among the N pixel sensor rows and sequentially transfers the readout signal to all even-numbered rows from among the N pixel sensor rows.

3. The apparatus of claim 2, wherein the image signal processor applies a linear model to one of the odd-numbered rows and one of the even-numbered rows that are adjacent to each other in the APS array to correct the image signals output from the uric of the odd-numbered rows and the one of the even-numbered rows.

4. The apparatus of claim 3, wherein the row driver sequentially transfers the readout signal to the odd-numbered rows and thereafter sequentially transfers the readout signal to the even-numbered rows.

5. The apparatus of claim 3, wherein the row driver sequentially transfers the readout signal to the even-numbered rows and thereafter the row driver sequentially transfers the readout signal to the odd-numbered rows.

6. The apparatus of claim 1, wherein the image signal processor receives the image signals for all odd-numbered rows of the N pixel sensor rows according to a predetermined order and thereafter receives the image signals for even-numbered rows positioned below the odd-numbered rows in the order of receiving the image signals for the odd-numbered rows.

7. The apparatus of claim 6, wherein the image signal processor applies a linear model to one of the odd-numbered rows and one of the even-numbered rows that are adjacent to each other in the APS array to correct the image signals output from the one of the odd-numbered rows and the one of the even-numbered rows.

8. The apparatus of claim 1, wherein the image signal processor sequentially receives image signals for (3n−2)-th (where n is a natural number) rows among the N pixel sensor rows,
sequentially receives image signals for (3p−1)-th (where p is an odd number) rows among the N pixel sensor rows, sequentially receives image signals for 3q-th (where q is a natural number) rows among the N pixel sensor rows, and sequentially receives image signals for (3r−1)-th (where r is an even number) rows among the N pixel sensor rows.

9. The apparatus of claim 8, wherein the image signal processor applies a log function model or an exponential function model to three adjacent pixel sensor rows among the N pixel sensor rows to correct the output image signals.

10. The apparatus of claim 1, wherein the APS array includes a plurality of active pixels in which an operation of a global shutter is available.

11. An apparatus for capturing images, the apparatus comprising:
an active pixel sensor (APS) array including a plurality of active pixels, and a plurality of transfer lines and selection lines connected to the plurality of active pixels, respectively, each of the active pixels including a photo diode and a storage diode;
a row driver that transfers a first driving signal and a second driving signal to the transfer lines and the selection lines, respectively; and
an image signal processor that corrects an image signal output by the APS array,
wherein the plurality of transfer lines and the plurality of selection lines are arranged for each row of the APS array to be connected with the active pixels positioned on the same row,
the first driving signal is simultaneously transferred to all of the plurality of active pixels,
the second driving signal is sequentially transferred to non-adjacent ones of the respective rows of the APS array, and
the image signal processor removes noise from the image signal by using image signals output from adjacent rows of the APS array.

12. The apparatus of claim 11, wherein each active pixel includes a drive transistor controlled by the first driving signal of the respective transfer line to provide an output of the photo diode to the storage diode, and a select transistor controlled by the second driving signal of the respective selection line to provide an output of the storage diode to the image signal processor.

13. The apparatus of claim 11, wherein the row driver sequentially transfers the second driving signal to odd numbered selection lines among the plurality of selection lines, and sequentially transfers the second driving signal to even numbered selection lines among the plurality of selection lines.

14. The apparatus of claim 11, wherein the row driver transfers the second driving signal to odd numbered ones of the plurality of selection lines according to a predetermined order and thereafter transfers the second driving signal to even numbered ones of the selection lines positioned below the odd numbered selection lines in the order of transferring the second driving signal to the odd numbered selection lines.

15. The apparatus of claim 11, wherein the row driver sequentially transfers the second driving signal to (3n−2)-th (where n is a natural number) selection lines among the plurality of selection lines, sequentially transfers the second driving signal to (3p−1)-th (where p is an odd number) selection lines among the plurality of selection lines, sequentially transfers the second driving signal to 3q-th (where q is a natural number) selection lines among the plurality of selection lines, and sequentially transfers the second driving signal to (3r−1)-th (where r is an even number) selection lines among the plurality of selection lines.

16. An image sensor, comprising:
an active pixel sensor (APS) array including N rows and M columns of image sensor pixels (where N and M are natural numbers of 2 or more); and
an image signal processor coupled to the APS array, wherein the image signal processor processes an image signal output by the APS array;
wherein each of the image sensor pixels is configured to generate an output signal indicative of image information stored therein in response to a readout signal;
wherein the image sensor is configured to apply the readout signal to the rows of the APS array in a non-sequential order of the rows of the APS array.

17. The image sensor of claim 16, wherein the image sensor is configured first to apply the readout signal sequentially to even numbered ones of the rows of the APS array and then to apply the readout signal sequentially to odd numbered ones of the rows of the APS array.

18. The image sensor of claim 16, wherein the image signal processor applies a model to one of the odd-numbered rows and one of the even-numbered rows that are adjacent to each other in the APS array to correct the image signals output from the one of the odd-numbered rows and the one of the even-numbered rows.

19. The image sensor of claim 16, wherein each of the image sensor pixels comprises a floating diffusion node that stores the image information, a drive transistor coupled to the floating diffusion node, and a select transistor coupled to the drive transistor, and wherein the readout signal is applied to the select transistor.

20. The image sensor of claim 16, wherein the image sensor is configured to apply the readout signal sequentially to even numbered and then sequentially to odd numbered ones of the rows of the APS array.
